(19) United States
(12) Patent Application Publication
(10) Pub. No.: US 2018/0163380 A1
(43) Pub. Date: Jun. 14, 2018

(54) HORIZONTAL DRINKING FOUNTAIN, SYSTEM, AND METHODS OF MAKING AND USING SAME

(71) Applicant: Maximilian Eugene Schommer, Irving, TX (US)

(72) Inventor: Maximilian Eugene Schommer, Irving, TX (US)

(21) Appl. No.: 15/378,293

(22) Filed: Dec. 14, 2016

(51) Int. Cl. E03B 9/20; B05B 12/12; B05B 12/00; B05B 15/06

(52) U.S. Cl. CPC E03B 9/20; B05B 15/061; B05B 12/002; B05B 12/122

(57) ABSTRACT

A dispenser of fluid is disclosed herein, comprising a fluid passageway in which a fluid to be dispensed flows out of the passageway through a fluid outlet in a generally horizontal manner, an actuator configured to permit an operator to control the passage of fluid through the outlet, and an altitude adjustment device configured to modify the height of the fluid outlet. Corresponding systems and methods also are disclosed.

### BACKGROUND

This disclosure relates generally to fluid dispensers, and more particularly to drinking fountains.

Drinking fountains are generally known. It is problematic when the operator of a drinking fountain must change their natural position in order to utilize the fountain. It is problematic when the operator is only able to utilize a portion of the fluid being dispensed, as opposed to the whole of the fluid. It is problematic when multiple machines need be installed in order to take multiple statures of operators into account. It is problematic when multiple machines must be used to fill various types of fluid receptacles. It is problematic when operators of exceptional stature have difficulty utilizing traditional drinking fountains because of the fountains awkward design.

It would be useful to develop a drinking fountain that doesn't waste fluid, and that is comfortable for the operator to use. It would be useful to develop a single machine that would replace the sets of machines traditionally used.

### SUMMARY

One embodiment described herein is a dispenser of fluid comprising a fluid passageway in which a fluid to be dispensed flows out of the passageway through a fluid outlet in a generally horizontal manner, an actuator configured to permit an operator to control the passage of fluid through the outlet, and an altitude adjustment device configured to modify the height of the fluid outlet.

### BRIEF DESCRIPTION OF THE DRAWINGS

FIG. 1 shows a front view of one embodiment of a Horizontal Drinking Fountain with an adjustable nozzle in a lower position.

FIG. 2 shows the same front view as FIG. 1, except the nozzle is raised to a higher position.

FIG. 3 is a side view of the drinking fountain, depicting what optionally could be inset into a wall.

FIG. 4 depicts a top view of the fountain.

FIG. 5 shows an isometric view of the drinking fountain.

FIG. 6 is a close view of the nozzle assembly, showing where the fluid is released from and the ergonomic form of the shell surrounding the nozzle.

FIG. 7 is a side view of the nozzle assembly shown, in FIG. 6.

FIG. 8 depicts a side section view through the nozzle assembly shown in FIG. 6, excluding parts surrounding the nozzle assembly for clarity.

FIG. 9 illustrates the back of the fountain.

FIG. 10 shows the nozzle assembly from the back.

FIG. 11 depicts the nozzle assembly in a side view.

FIG. 12 shows an exploded side view of the nozzle assembly.

FIG. 13 is an exploded front view of the nozzle assembly.

FIG. 14 is an exploded isometric view of the nozzle assembly.

FIG. 15 is a front view of the face plate.

FIG. 16 is a diagram describing some of the various possible inputs into the fountain.

FIG. 17 is a diagram depicting the possible methods of controlling the actuators of the fountain.

FIG. 18 is a front view of an embodiment of a-drinking fountain containing the nozzle assembly shown in FIG. 6.

FIG. 19 is a side of an embodiment of a drinking fountain containing the nozzle assembly shown in FIG. 6.

FIG. 20 is a front view of an embodiment of a drinking fountain containing the nozzle shown in FIG. 8.

FIG. 21 is a top view of the face plate.

FIG. 22 is a side view of the face plate.

FIG. 23 is a back view of the face plate.

FIG. 24 is an isometric view of the face plate.

### DETAILED DESCRIPTION

The Horizontal Drinking fountain is a device for delivering fluid to an operator that is more convenient, more ergonomic, more efficient, and more versatile than traditional drinking fountains. By having fluid dispensed in a generally horizontal manner, the operator can receive fluid in a comfortable position. The adjustable height nozzle allows any operator, regardless of stature, to use the fountain just as easily, eliminating the need for multiple machines to fit different use cases.

By its operation, the drinking fountain ensures that all of the fluid that leaves the nozzle enters the operator's fluid receptacle. This is because the stream of fluid can be precisely and rapidly actuated by the operator in an intuitive manner. The fountain also allows for filling of fluid containers just as easily, eliminating the need for a separate device to fill containers.

In embodiments the fluid outlet (106) emits the fluid stream in a direction that is about −10 degrees to about 45 degrees upward relative to a horizontal plane, or about 0 degrees to about 30 degrees upward relative or a horizontal plane, or about 0 degrees to about 15 degrees upward relative to a horizontal plane.

FIG. 1 shows the front of the Horizontal Drinking Fountain (100). The front panel (110) is the covering that is typically flush or near-flush with the wall in which the fountain is mounted. This panel can be any solid, non-toxic material, or near-solid material but ideally will be stainless steel or a hardwood. The panel can be made to match the aesthetics of the surroundings, allowing for smooth blending into any environment. The nozzle assembly (102) is the moving component that houses the nozzle (106) and actuator (104), such as button, for actuation. The nozzle assembly (102) moves vertically along the slider slot (108), and is moved by the operator. The slider slot (108) is uncovered in this depiction, but may be covered as well by a number of methods, including brushes mounted to the sides of the slider slot, or a sliding plate that moves along the slider slot with the nozzle assembly (102), or various other methods.

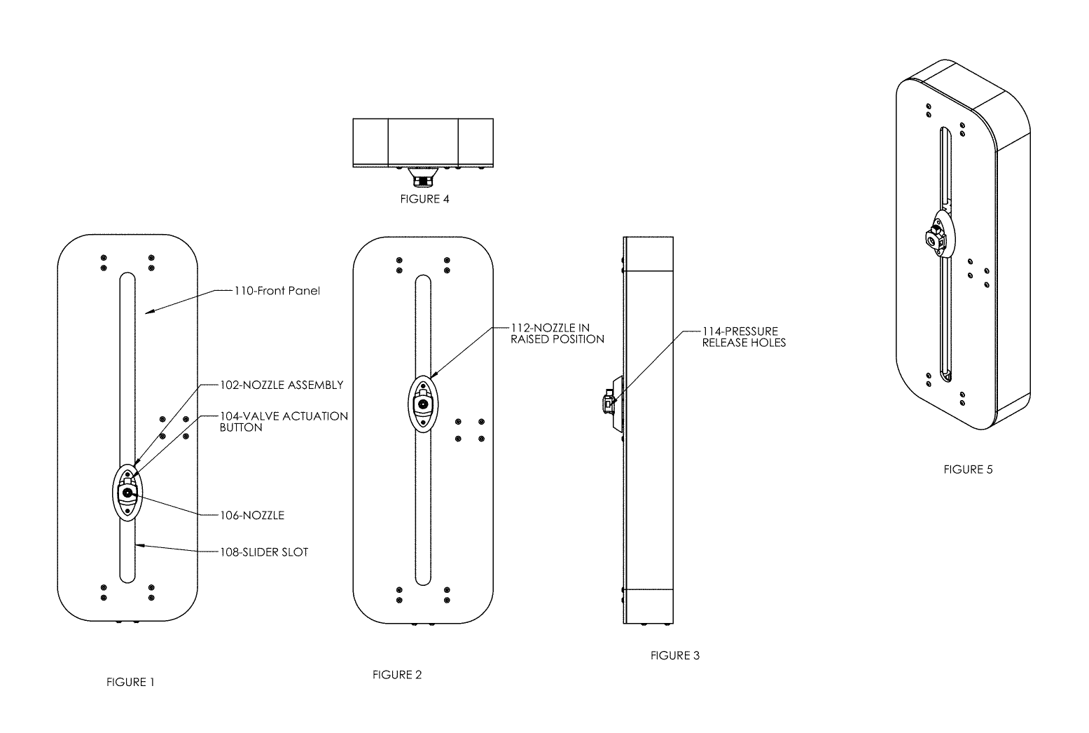

FIG. 2 illustrates the same fountain, except where the nozzle assembly is in a raised position designated as (112), demonstrating the adjustable design. The nozzle assembly can be made to travel any distance simply by altering dimensions of the fountain (100). In the preferred embodiment, the fountain will be comfortable to use by the 1% female and the 99% male, and larger range can be sought simply by expanding the fountain. The fountain can also be constructed such that operators in a sitting position can easily use it as well.

FIG. 3 shows a side view of the fountain. The pressure release holes (114) prevent the nozzle from being blocked by the operator and pressure buildup that would ensue. This allows the fountain to remain sanitary, as direct contact with the nozzle is very difficult, and does not result in an increase of drinking pressure, and is thus discouraged.

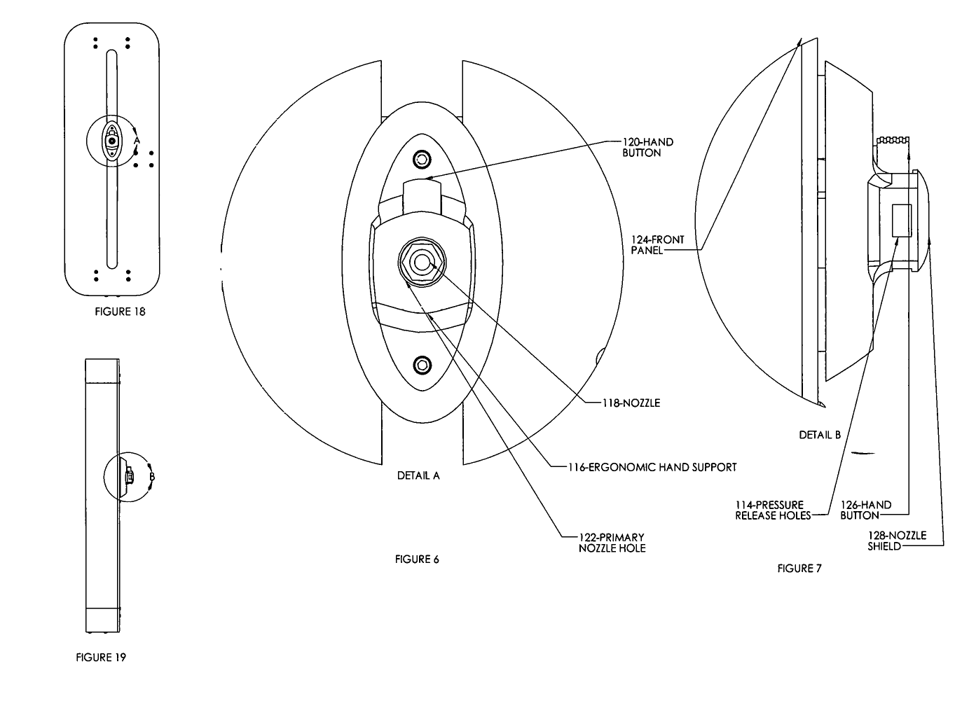

FIG. 4 shows the top of the fountain of the preferred embodiment, again ignoring the surrounding wall and the implied inset into the wall. Other embodiments could be mounted in other ways.

FIG. 5 is an isometric view of the fountain, displayed such that the nozzle is in a raised position established by the operators' power. The preferred method of mounting the fountain is inset into a wall such that the front panel (110) is flush against the wall. The fountain can be secured using various methods, such as fixing to a stud or structural section of the wall using bolts or screws, or by mounting to the paneling of the wall. The fountain can also be fixed to the outside of a structure using its own body to mount. The fountain can also be designed with additional structure to be a standalone device, not requiring a wall for support.

FIG. 6 shows close up detail (A) of the front of the nozzle assembly (102) of the drinking fountain shown in FIGS. 18-19. In the center is the nozzle (118). The shell surrounding the nozzle and the valve is designed in this embodiment to be held by the operator during use, and is designed in this embodiment to be held in a natural position by a human operator's hand. The actuator (120) that is shown is a button to be actuated by the operator in a natural fashion, and thus an ergonomic hand support (116) is used to improve operator experience, and increase usability of the device. The primary nozzle hole (122) is a clearance hole for the stream of fluid emanating from the nozzle (118). This allows passage of fluid, but discourages contact of the operator with the nozzle (118) by causing contact with the nozzle shield (128) instead. The hand button (120, 126) in the depicted embodiment is typically actuated by the index finger of the operator, and the thumb of the operator surrounds the ergonomic hand support (116), allowing for adjustment of the nozzle assembly's (102) height. The nozzle assembly (102) may also contain sensors to detect the operator and the position of the operator in order to evaluate whether to release water from an electronically operated valve and to actuate the position of the nozzle assembly (102) based on the sensors' evaluation of the operator.

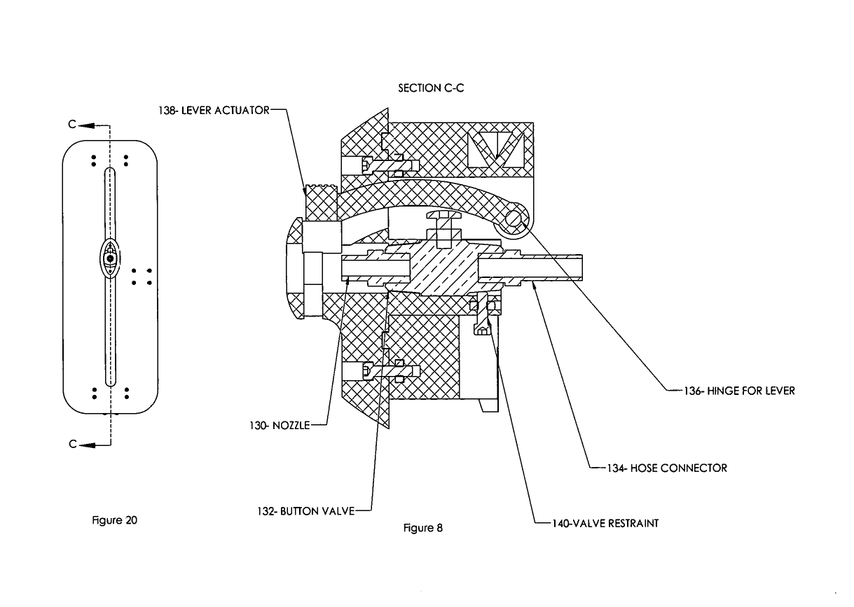

FIG. 7 shows a side view (B) of the nozzle assembly depicted by FIG. 6. As can be seen in this figure, there are pressure release holes (114) surrounding the nozzle shield (128). These serve to allow fluid to displace to other locations if the primary nozzle hole (122) is blocked. This feature discourages unsanitary behavior of the operators. The pressure release holes (114) shown also prevent stagnation of fluid that, either by operator intervention or by usual operation, does not exit the nozzle shield (128). This helps with keeping the nozzle sanitary.

FIG. 8 shows a section view (C) of the nozzle assembly of the drinking fountain shown in FIG. 20. In the depicted embodiment, the lever actuator (138) must be depressed by the operator in order to actuate the button valve (132). When the lever actuator (138) is depressed, it is restrained by a hinge (136) that allows the force from the operator to be transferred through contact to the button valve (132). The lever actuator (138) is designed to be easy to actuate rapidly, so as to allow the operator precise control of the flow of fluid through the nozzle (130). The valve restraint (140) allows the button valve to be installed easily into the nozzle assembly (102) and then become constrained by adjusting the screw to tighten the valve restraint against the button valve (132), preventing the button valve from moving, while allowing easy disassembly. The hose connector (134) is connected to the inlet of the button valve (132) and allows for a hose to be attached to the end of the hose connector by sliding the hose over the connector, and clamping it with hose clamp to prevent fluid leakage.

FIG. 9 depicts a view of the fountain from behind. The nozzle assembly (102) slides vertically along the bearing track (142) on a set of linear bearings. The bearing track is loosely constrained by the bearing track aligning and restraining pieces (150). These allow the bearing track to remain roughly vertical, but prevent the nozzle assembly from becoming over constrained and binding the linear bearings (152). Methods to resist motion may be employed for the nozzle assembly in order to improve the operator's experience. Such methods may include counterweights attached to a pulley system to resist the nozzle assembly (102) from falling due to gravity, or a friction system or fluid coupling or electric motor used to resist motion of the nozzle assembly (102). Automatic actuation of the linear sliding mechanism is possible as well, given electric inputs.

The fluid tube (146) is held in place by the fluid tube restraint (148) such that the length of the fluid tube (146) from the nozzle assembly (102) to the fluid tube restraint (148) is more than half the length of the bearing track (142). This allows the nozzle assembly (102) to travel along the bearing track smoothly while having slack in the fluid tube (146) such that constant pressure from the fluid source is maintained. The fluid tube restraint (148) is mounted in such a way that kinking of the fluid tube (146) is prevented. In this embodiment, the fluid tube is made out of a flexible, pressure capable material that is resistant to kinking. Various mounting methods can be employed for the hose to minimize the radius of curvature, such as holding parts of the hose by extended springs, or wrapping the hose in a case capable of a minimum curvature higher than the curvature required to kink the hose. The depicted embodiment relies on pressure and slack from the hose to prevent kinking.

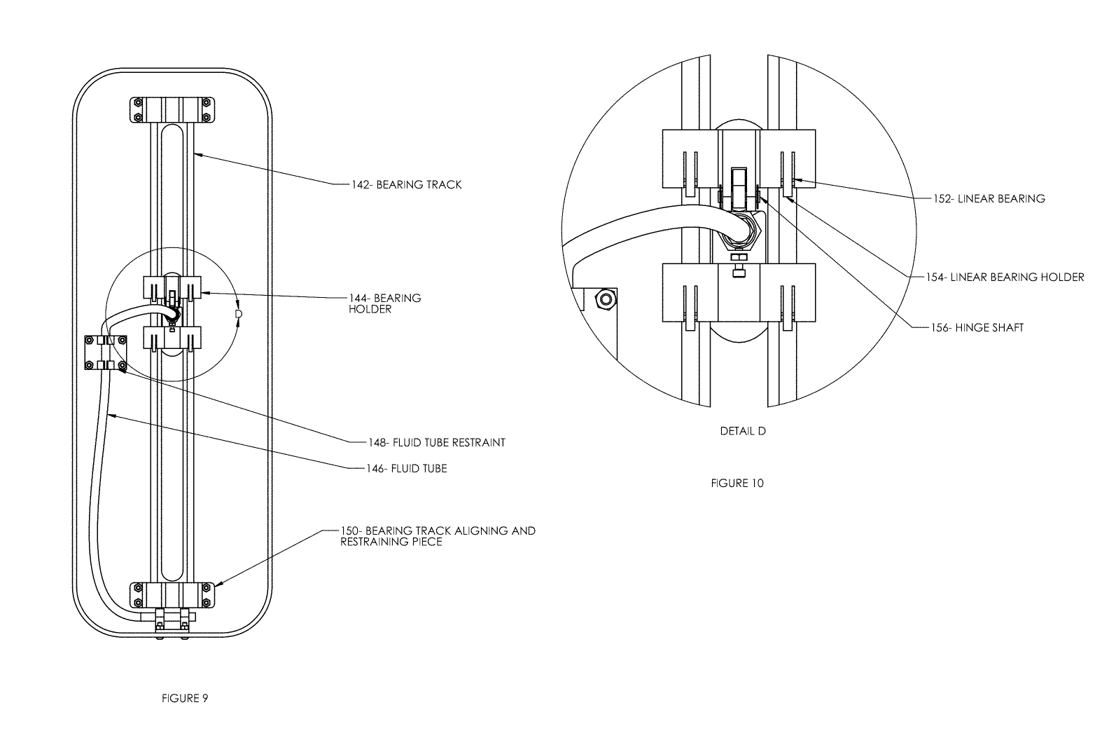

FIG. 10 shows a detail view of the rear of the nozzle assembly (102). The nozzle assembly (102) contains linear bearing holders (154) that hold linear bearings (152). The linear bearings (152) slide up and down the bearing track (142), and allow for smooth, long term operation of the fountain (100). In the depicted embodiment, the linear bearings (152) are inserted into cavities in the linear bearing holders (154) and clip in after being inserted fully. This allows for tool-free assembly and maintenance of the track (142) and bearings (152) if necessary. The lever actuator (138) hinges on the hinge shaft (156), which is restrained by a pair of restraining rings. These rings can be easily removed in order to access the valve (132) for maintenance.

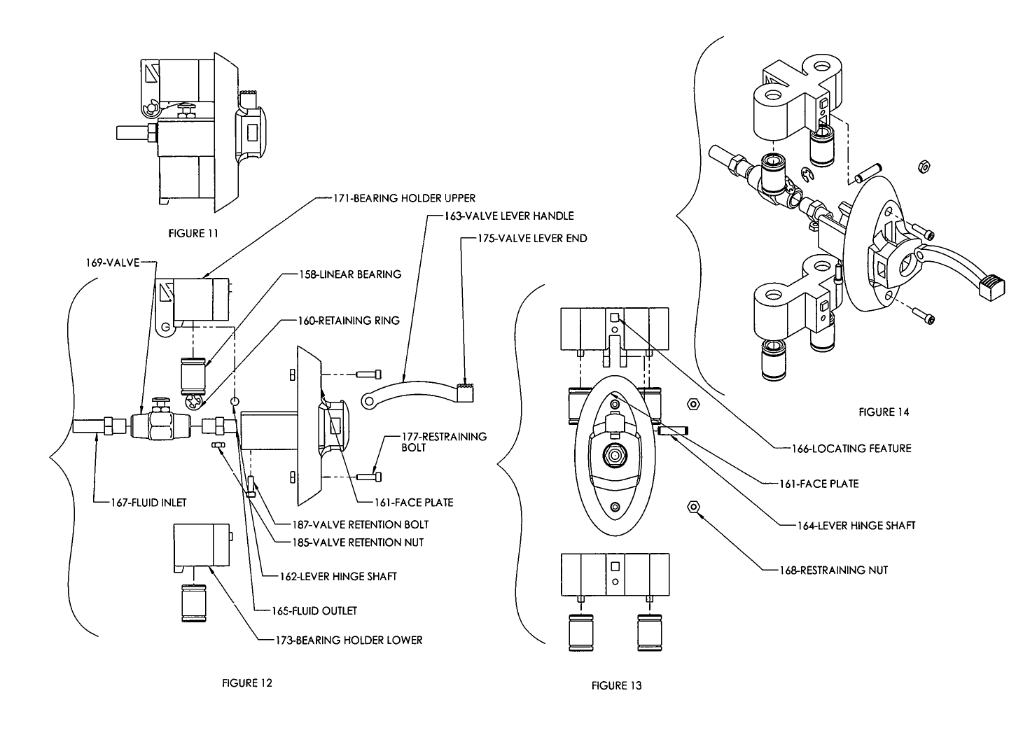

FIG. 11 depicts a side view of the nozzle assembly unexploded. FIG. 12 shows the same view with the exploded assembly, displaying the various parts of the assembly and how they fit together. The linear bearings (158) fit into the bearing holder upper (171) and bearing holder lower (173). The button valve (169) is then assembled with the fluid outlet (165) and the fluid inlet (167), and then inserted into the face plate (161) using the locating features (166), and secured using bolts (177) and inserted restraining nuts (168). The valve lever (163) as depicted is assembled in two pieces, one is the handle (163) and the other is the lever end (175), inside the face plate (161). FIG. 13 depicts the exploded view from the front of the nozzle assembly (102). FIG. 14 is an isometric view of the nozzle assembly (102) exploded.

FIGS. 15 and 21-24 depict the face plate (161) in multiple views (top, front, side, back, and isometric). The face plate in this embodiment is designed to be aesthetically pleasing, comfortable for the operator to interact with, ergonomic, and sanitary. The smoothed skirt (170) ensures that the operator's hand naturally follows the slope and grips the top of the face plate grip (181) with their index finger, and the bottom (183) with their thumb. This mode of gripping the face plate (161) ensures a comfortable user experience, and the ability to precisely control the button valve (169). The recessed mounting features (176) allow the face of the face plate (161) to be smooth and lacking of visible hardware. In the depiction, the recessed features are not plugged, but the features could also be plugged such that the surface of the feature is flush with the face plate (161). The nozzle guard (172) is the feature which surrounds the fluid outlet or nozzle (165, 130, 118, 106). The nozzle is designed such that laminar flow of fluid is achieved by the fluid exiting the nozzle. Many shapes of nozzles may be used with varying pressures and interfaces in order to achieve various goals (filling bottles, drinking directly, minimize pressure change, maintain constant fluid flow, etc.). The embodiment shown has a fixed nozzle, but it may also be constructed such that the nozzle may move to multiple angles to achieve various goals.

The valve containment feature (182) restrains the button valve (169) with the help of the valve retention feature (182) which holds a nut (187) and allows passage of a bolt (185) to constrain the valve (169). The lever restraining feature (184) constrains the lever within the plane of motion of the hinge (162) the lever moves on. The locating feature (186) ensures proper alignment of the bearing holders (171, 173) so as to ensure smooth sliding along the bearing track (142). In this embodiment the faceplate (161) has no assistive features for proper targeting of fluid into the fluid receptacle of the operator. In many cases, the fluid receptacle is the user's mouth, or a cup, drinking glass or bottle. The fountain can be constructed such that the operator is made aware of the likely path of the fluid as well as the current location of the fluid receptacle of the operator. This may be done by placing a mirror on the face plate (161) as well as targeting features such that when viewed by the operator, if the fluid receptacle of the operator is contained within the targeting features, then the fluid will likely flow into the fluid receptacle of the operator. This may also be done using a sensor (infrared distance sensor, thermal sensor, camera, etc.) and an indicator of some sort (LED, audible tone, solenoid valve activation, etc.) to ensure that fluid enters the fluid receptacle of the operator.

The fluid clearance feature (174) insures that nozzle (165) is difficult to contact by the operator, yet fluid may still pass unobstructed into the operator's fluid receptacle. This is achieved by separating the nozzle (165) and the nozzle guard (172) and clearance feature (174) from each other by a distance. The clearance feature (174) is large enough such that the fluid flowing from the nozzle (165) does not make contact with the edge of the feature, yet small enough to prevent accidental contact of the operator with the nozzle (165). This feature in combination with the sanitary fluid release features (178) help keep the fountain clean. The fountain could be configured such that anti-microbial materials are used for all parts that interact with the operator. It could also be configured such that it cleans itself by radiating ultraviolet light on parts that interact with the operator, thus killing bacteria while not harming the operator. The fountain may also contain modules with cleaning materials such that the operator may use the cleaning materials as desired. The fountain may also be constructed such that a fluid drain exists in the path of fluid travel on the floor, or other non-obstructive surface such that if fluid does miss the operator's fluid receptacle, no injury of the operator or unsanitary fluid stagnation shall occur. The fountain could also be configured such that any fluid caught flowing back into the body of the fountain is routed into a drain such that no part of the fountain allows fluid to stagnate or to damage the fountain or surrounding entities. The fountain may also be configured to have a mesh or wire guard in front of the nozzle (165) further preventing contamination.

The valve (169) depicted is a button valve, but may be any actuator that is capable of actuating the flow of fluid. The valve need not be located in the nozzle assembly (102) but may be located anywhere along the path from the fluid source to the fluid outlet (165).

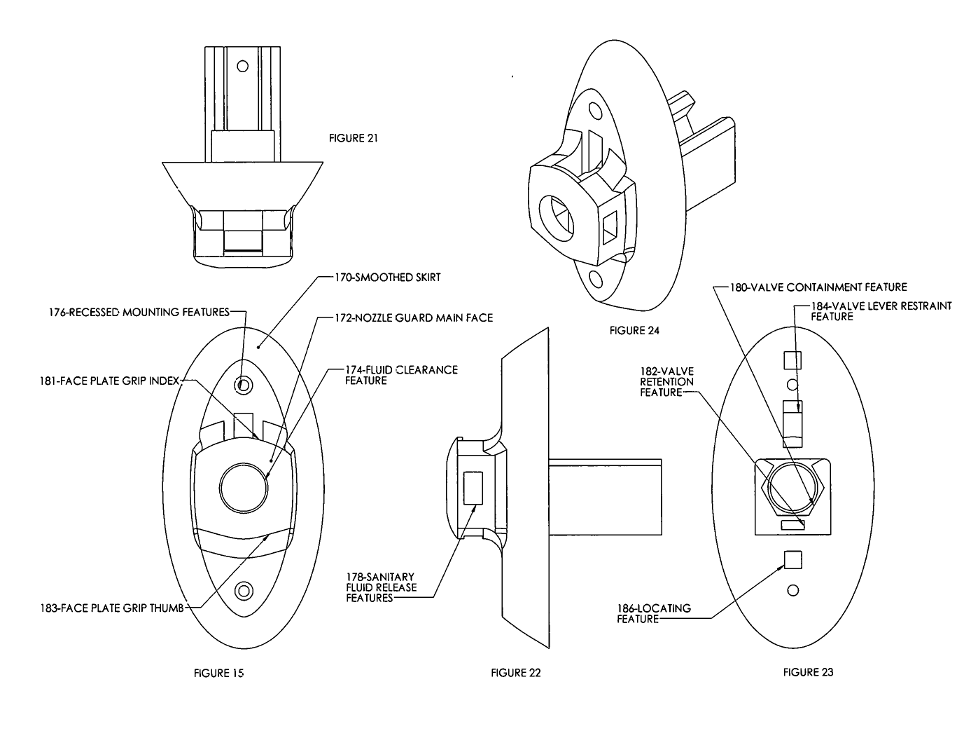

FIG. 16 shows other possible configurations of the fountain, which may be used in any combination and need not all be present. A pressure regulator may be used in order to ensure proper laminar flow and optimal operator experience. A pressure regulator may also be used to control the fountain to function identically no matter what the source fluid pressure is, so that use of one fountain in one area is identical to use in another area, preventing operator error resulting from learned expectations and thus improving the operator's experience. In the situation where there is no external pressure, a pressure regulator may be used in combination with a device that produces pressure in order to achieve uniform flow. A pressure regulator may be used to ensure equal flow rates from any height that the nozzle assembly (102) achieves. A pressure regulator may also be used to control the mixing of multiple fluids, such that the operator may choose from a variety of mix ratios to exit from the nozzle (165).

A temperature control device may be used in order to regulate the temperature of the fluid such that the fluid is of a temperature that improves the operator's experience of the device. A temperature control device may also be used in order to prevent phase change of the fluid, thus preventing damage to the device and improving the operator's experience. A temperature control device may also be used to deliver fluid of the desired temperature to the operator.

A fluid filter may be used to alter the quality of the fluid, thus improving the operator's experience. A fluid filter may also be used to alter the fluid such that the operator desires the fluid that has been filtered more than the fluid that has not. A fluid filter may be used to remove impurities of the fluid that would cause harm to the operator or to the fountain.

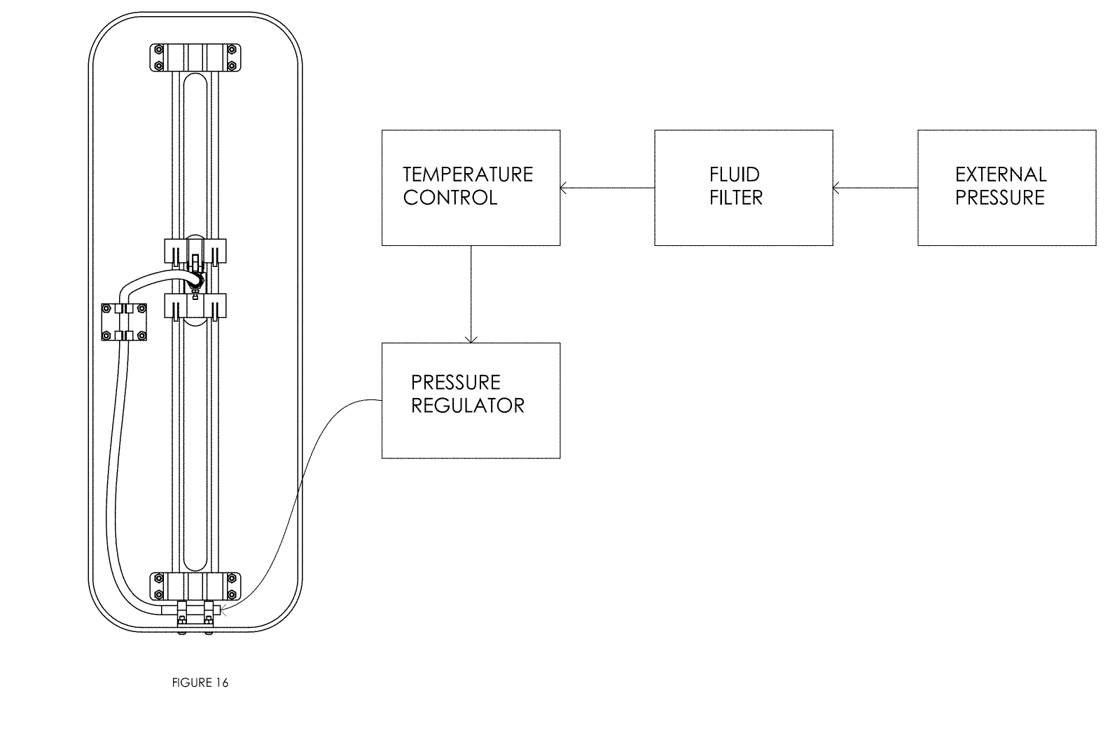

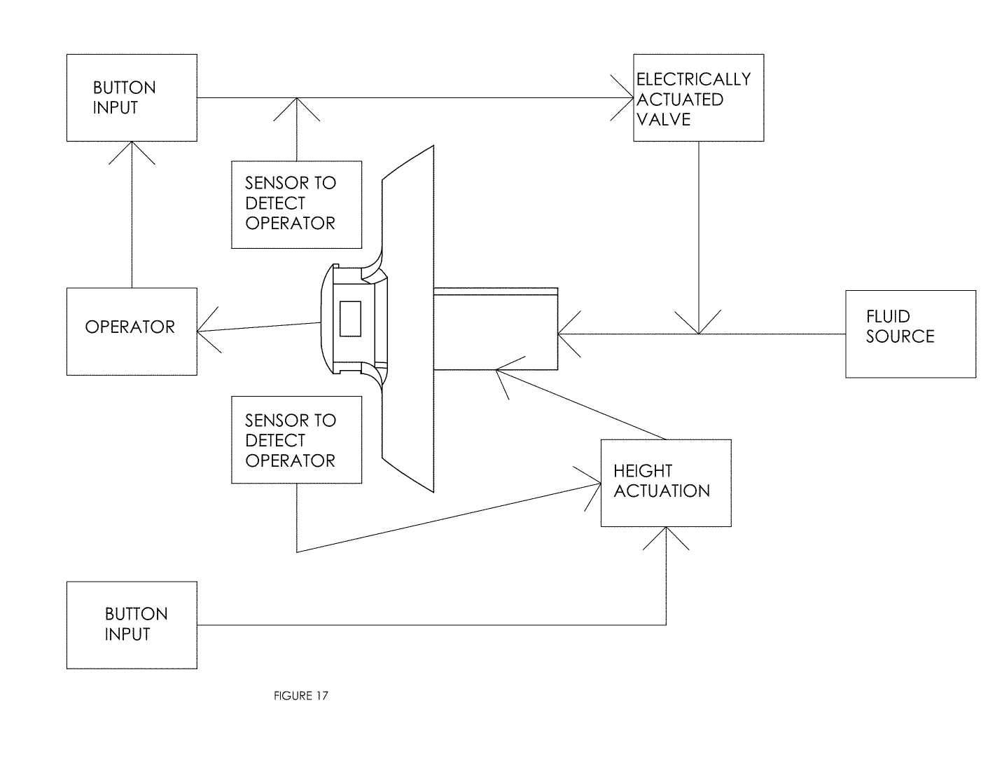

FIG. 17 depicts other possible configurations of the fountain. The fountain may be configured such that a sensor of some kind is placed such that it detects information about the operator. The operator may then actuate a button input, or another kind of input that carries information about the operator's interaction with the fountain, that will represent the operator's desire to receive fluid from the fountain. A sensor may then detect the operator, and depending on its value, determine whether an electrically actuated valve opens in order to send fluid to the operator.

The height of the nozzle assembly (102) may be controlled by a button input of the operator, or by a sensor to detect the operator and thus actuate the height of the nozzle assembly.

Let it be noted that a typical drinking fountain operates with a flow rate of 0.75-2 gallons per minute. The diameter of a typical orifice is 0.125 in. This results in a flow velocity of around 7 feet per second. At a 10 degree incline from the horizontal, the water will begin to fall below the start point at 7 inches away, reaching a maximum height of 0.4 in above where it began. This is a roughly horizontal flow given that the operator will typically be located at a distance less than 7 in from the nozzle. The pressures and angles and nozzle diameters may be altered to achieve different characteristics of flow.

In embodiments, the drinking fountain is dimensioned such that the lowest elevation of the nozzle is about 0.25 meters off of the ground, or about 0.75 meters off of the ground, or about 1 meters off of the ground. In embodiments, the drinking fountain is dimensioned such that the highest elevation of the nozzle is about 3 meters off of the ground, or about 2.5 meters off of the ground, or about 2.12 meters off of the ground. In some cases, the nozzle is made of a polymeric thermoplastic material, a polymeric thermoset material, a metal, or an antimicrobial plastic.

A number of alternatives, modifications, variations, or improvements therein may be subsequently made by those skilled in the art, which are also intended to be encompassed by the following claims.

What is claimed is:

1. A dispenser of fluid comprising:
a. a fluid passageway in which a fluid to be dispensed flows out of the passageway through a fluid outlet in a generally horizontal manner,
b. an actuator configured to permit an operator to control the passage of fluid through the outlet, and
c. an altitude adjustment device configured to modify the height of the fluid outlet.

2. The dispenser of claim 1, wherein the altitude adjustment device automatically modifies the height of the fluid outlet.

3. The dispenser of claim 2 wherein the altitude adjustment device automatically modifies the height of the fluid outlet by taking user input via an electrical input.

4. The dispenser of claim 2 wherein the altitude adjustment device automatically modifies the height of the fluid outlet by sensing the height of the user.

5. The dispenser of claim 2 wherein the altitude adjustment device automatically modifies the height of the fluid outlet by sensing the fluid receptacle of the operator.

6. The dispenser of claim 1, wherein the altitude adjustment device is controlled directly by the user through an interface.

7. The dispenser of claim 6, wherein the interface is a sliding mechanism that the user controls under their own power.

8. The dispenser of claim 6 wherein the actuator is controlled directly by the user under the user's power.

9. The dispenser of fluid of claim 1, wherein the fluid outlet comprises a nozzle.

10. The dispenser of fluid of claim 1, further comprising a fluid collector disposed beneath the fluid outlet such that misdirected fluid does not accumulate.

11. The dispenser of fluid of claim 1, further comprising a pressure regulator configured to adjust the pressure of fluid flow through the fluid passageway based on nozzle height such that the height of the fluid passageway does not affect the flow of the fluid.

12. The dispenser of fluid of claim 1, further comprising a thermal regulation system such that the temperature of the fluid may be controlled before exiting the fluid passageway.

13. The dispenser of fluid of claim 1, further comprising a referencing system such that the operator is guided by the referencing system to correctly orient their fluid receptacle.
